(19) United States
(12) Patent Application Publication
(10) Pub. No.: US 2008/0107858 A1
(43) Pub. Date: May 8, 2008

(54) Polycarbonate for transparent injection-molded articles

(75) Inventors: Alexander Meyer, Dusseldorf (DE); Wolfgang Ebert, Krefeld (DE); Wilfried Haese, Odenthal (DE); Gabriele Kretschmar, Krefeld (DE); Burkhard Reitze, Bergisch Gladbach (DE); Thomas Winzen, Duisburg (DE); Friedrich-Karl Bruder, Krefeld (DE); Bert Ruytinx, Halen (BE); Alexander Karbach, Krefeld (DE); Matthias Voetz, Leverkusen (DE); Andreas Pogoda, Kamp-Lintfort (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/977,616

(22) Filed: Oct. 25, 2007

(30) Foreign Application Priority Data
Oct. 31, 2006 (DE) 102006051309.6

(51) Int. Cl. B32B 17/10; B32B 3/02

(52) U.S. Cl. 428/64.1; 428/339

(57) ABSTRACT

A polycarbonate resin comprising fluorescing particles that feature a particular size distribution is disclosed. The size distribution of these particles that fluoresce upon excitation at wavelengths of 400-440 nm, 50× magnification and illumination time of 40 msec per scan was found to be critical in determining the suitability of the resin for optical, particularly optical storage, applications.

### FIELD OF THE INVENTION

The invention relates to polycarbonate and more particularly to polycarbonate suitable for making optical storage media.

### TECHNICAL BACKGROUND OF THE INVENTION

The transparent injection molded articles may for example be transparent sheets, lenses, optical storage media, or also articles from the automotive glazings sector, such as for example headlamp lens, in which a high optical quality is necessary.

Transparent injection molded bodies are important above all in the glazings and storage media sectors.

Optical data recording materials have in recent times been used to an increasing extent as a variable recording and/or archiving medium for large amounts of data. Examples of this type of optical data storage media include CDs, super-audio-CDs, CD-Rs, CD-RWs, DVDs, DVD-Rs, DVD+Rs, DVD-RWs, DVD+RWs and BDs.

Transparent thermoplastic materials, such as for example polycarbonate, polymethyl methacrylate and chemical modifications thereof, are typically used for optical storage media. In particular aromatic polycarbonate, especially polycarbonate based on bisphenol A, are suitable as substrate material particularly for write-once and read-many as well as for write-many optical discs. Polycarbonate is likewise suitable for the production of molded parts in the automotive glazings sector, such as for example scattered light discs. This thermoplastic material has an excellent mechanical stability, is only slightly susceptible to dimensional changes, and is characterized by a high transparency and impact strength. In order to store larger amounts of data on a data carrier, formats such as DVDs have been developed from CDs. On account of their increased storage capacity these enable films for example to be stored. Thus, compared to CDs DVDs have a six-fold to eight-fold greater recording capacity. This became possible by reducing the laser wavelength from ca. 780 nm to ca. 655 nm in the DVD format. In addition the numerical aperture of the optical reading system was increased.

The development of new formats, such as for example HD-DVDs (high density DVDs) or the so-called Blu Ray Disk (BD) in turn operate at shorter laser wavelengths. BDs are read through a transparent cover layer material (PC film).

Accordingly the demands placed on the transilluminated substrate material or the transilluminated cover layer materials are becoming increasingly higher. The greater the storage density of the respective medium, the higher are the qualitative requirements (e.g. low particle content) on the substrate material. Defects in the transilluminated substrate layer or in the transilluminated cover layer material lead to errors in the reading process.

Thus, especially defects that may interact with the laser beam of the reading system are of particular relevance as regards an error-free reading process. As is generally known, defects include foreign particles, such as for example dust particles or metal particles that may absorb and/or scatter the laser beam. In addition, due to the reduction of the wavelength of the reading laser those particles whose absorption is within the wavelength of the laser that is used are critical. With HD-DVDs (high density DVDs) or Blu Ray disks this occurs for example at wavelengths between 400 nm and 410 nm.

On account of their absorption behavior these particles exhibit a characteristic, interfering fluorescence when illuminated under UV light.

It is known that substrate materials for optical data storage media contain foreign substances. In EP-A 379130 it is for example described that these foreign substances can have a negative influence on the writing or reading of an optical data carrier by means of a laser beam. A substrate material then has a good quality if a specific particle content (particle index), described in this patent, lies below a certain value. The foreign substances may be dust or a carbonized material. These foreign substances, which have to be clearly differentiated from substrate material, are detected in a solvent in which the substrate material itself is soluble. The foreign substances which can be detected in this solvent are not covered by the present invention. The foreign particles described here cannot be detected in a solvent in which the substrate material is soluble, since they have a similar refractive index to polycarbonate. Thus, these particles cannot be detected for example by a Hyac Royco particle test corresponding to the prior art, as is described for example in DE 10248951.

In JP-A-02-135222 foreign bodies with a gel-like character are described, which have a refractive index different from that of the matrix. These particles may likewise adversely affect the quality of the optical data storage medium. These particles can be significantly reduced by for example adding water in an extrusion process. These particles differ from the particles described here since the refractive index of the particles described here does not differ substantially from that of the matrix. Furthermore, the particles described here cannot be removed and their content cannot be reduced by adding water in an extrusion process. Also, in JP-A-02135222 only the number of particles is regarded as relevant. It is assumed that all particles have the same size, and that all particles cause the same damage.

In U.S. Pat. No. 6,723,824 B1 foreign particles in polycarbonate produced by the melt transesterification are described, which fluoresce when illuminated with light of a wavelength of 380 nm and have a particle size of 30 μm or larger, and which according to an ageing test lead to “white spots” in an injection molded body.

In contrast to U.S. Pat. No. 6,723,824 B1 the present invention describes particles which are to some extent significantly smaller than 30 μm and having a different flow behaviour than that of the substrate material and thus can lead to surface irregularities in the resulting injection molded article.

A polycarbonate with transparent foreign particles is described in JP2001-310935. These foreign particles differ from the polymer matrix in terms of their refractive index. No information is given regarding the fluorescent properties of these particles. Also, no size distribution is described.

### SUMMARY OF THE INVENTION

A polycarbonate resin comprising fluorescing particles that feature a particular size distribution is disclosed. The size distribution of these particles that fluoresce upon excitation at wavelengths of 400-440 nm, 50× magnification and illumination time of 40 msec per scan was found to be critical in determining the suitability of the resin for optical, particularly optical storage, applications.

### DETAILED DESCRIPTION OF THE INVENTION

It was now surprisingly found that the size of the individual particles that emit fluorescent light at an excitation wavelength of 400-440 nm (herein referred to as “fluorescing particles) is varying, and that these particles may, on account of their viscous behavior, disintegrate for example as a result of the extrusion process. It is possible to obtain a much more accurate prediction of the quality of the substrate material by evaluating the size distribution of the fluorescing particles.

It was found that substrate materials, in particular substrate materials based on polycarbonate, contain particles which emit fluorescent light at an excitation wavelength of 400-440 nm, the wavelength lying within the aforedescribed critical absorption spectrum of a blue laser. It was surprisingly found that these fluorescing particles have physical properties different from the polymer matrix (polycarbonate) itself. The locations of these particles, referred to as defect sites in the substrate material, may lead to surface defects in the finished injection molded part, such as for example an optical disc. The fluorescing particles are characterized by the following properties:

Measurements of the mechanical properties of the particles reveal a higher modulus as well as a greater hardness compared to the matrix material (polycarbonate). The hardness of the particles is in this connection up to 0.3 GPa higher than that of the matrix. The hardness values were determined on a disc surface (particles vs. matrix) using a nanoindenter from the Hysitron company.

Depending on the position of the fluorescing particles in the injection molded body, flow interferences and thus surface defects are triggered on the surface of the injection molded body. These surface defects, which themselves fluoresce (due to the fluorescent particle), are relevant not only for optical data storage media that are transilluminated with a blue laser, but are also relevant for other injection molded bodies, such as for example lenses or headlamp lenses, since these surface defects generally adversely affect the optical quality. With optical data storage media these surface defects are detected by a scanner in the production process. The defective discs are sorted out.

The optical defect (surface defect) on an injection molded body may in the case of a disc extend over a length of several millimetres and is referring to the disc shape radially orientated. An elongated fluorescing particle occurs within this optical defect. It was found that the elongated fluorescing particle, for example in discs, have a length/width ratio of 2-30, on average of 5-15. The length of the elongated fluorescing particle is between 10 and 200 μm. These values depend to a large extent on the adjusted machine parameters in the injection molding process, above all on the cycle time.

It was also found that the fluorescing bodies exhibit a relaxation behavior. After these fluorescing elongated particles have been heat treated for two minutes at 300° C., a length/width ratio of ca. 1 is found, i.e. the elongated fluorescing particle relaxes to form a spherical body.

The elongated fluorescing particle exhibit a certain swelling behavior. If dichloromethane is added to this flow interference for 5 minutes, then an increase in the surface area of the fluorescing region is obtained. The volumetric increase of the defect was determined from this—an increase by a factor of 1.1 to 3.5 is found (the spherical volume of the defect was determined from the radius of the circle having the same size). On average an increase by a factor of 2 is obtained. The polymer matrix itself in the case of polycarbonate dissolves completely in dichloromethane, whereas the fluorescing body remains intact.

It was furthermore found that the fluorescing particles adopt specific colour values. For this purpose the particles were illuminated with light from a mercury vapour lamp through a step filter allowing transmission from 470 nm. The colour of the particles was determined according to the HSI (hue, saturation, intensity) colour model with a Zeiss Axioplan HRc digital colour camera built into a Zeiss Axioplan 2 microscope. The method is described for example in “Digitale Bildverarbeitung mit dem PC” (Digital Image Evaluation with the PC) by Hans-Jürgen Schlicht, Addison-Wesley, 1993. If the colour of the fluorescing particles is measured, then a hue value of on average ca. 80° (from a minimum 20° up to a maximum 180°), a colour saturation of on average 150 digits (minimum 10 up to maximum 190) and a colour intensity of on average 190 digits (from a minimum 50 up to a maximum 255) are found. The colour of the matrix in the case of polycarbonate (compact disc) has a hue value of ca. 75° (from a minimum 74° up to a maximum 78°), a colour saturation of on average 133 digits (minimum 132 up to a maximum 134) and a colour intensity of on average 36 digits (from a minimum of 35 up to a maximum of 37).

The larger the number of fluorescing particles of a certain size in the polymer granules, the greater is the probability of occurrence of surface defects in the finished injection molded body. The rejection rate of the respective product is thus increased. It was surprisingly found that not all fluorescing particles lead to surface defects, but only particles of a certain size. Fluorescing particles that lay underneath the surface defects were removed from optical discs by microtome and relaxed in the melt as described above. Simply spherical particles with a diameter of ≧10 μm were determined. This result was not obvious.

The object therefore existed of providing an extremely pure substrate material, preferably of polycarbonate, which is suitable in particular for the production of data carriers, especially those data carriers that can be read with blue laser light, as well as for the production of high quality optical injection molded bodies.

In order to achieve this object the particles critical for the injection molding process had to be identified and a method for detecting these particles had to be made available, in order thereby to determine the size distribution of fluorescing particles that is critical for a qualitatively high-grade injection molded body. The desired material could then be made available. This material is suitable in particular for the production of optical carriers such as CDs and DVDs, in the production of which short cycle times of for example less than 4 sec, preferably less than 3 sec, and particularly preferably 0.3 to 1.5 sec, are important.

The present invention accordingly provides a substrate material, preferably of polycarbonate, which has a specific size distribution of fluorescing particles with particle diameters per unit amount of substrate material. The present invention accordingly provides a polycarbonate and a substrate material, characterised in that the distribution of the particle diameter of fluorescing particles evaluated after dissolving 50 g of polycarbonate in 700 ml of dichloromethane and filtering through a Teflon filter of 5 μm pore size at an excitation wavelength of 400-440 nm and with a 50× overall magnification with an illumination time of 40 millisec in the polycarbonate is as follows (counts per gram of polycarbonate):
8.0-≦10 μm: 0.02-2.4 counts/g, preferably 0.02-1.2 counts/g
>10-≦20 μm: 0.02-2.4 counts/g, preferably 0.02-1.6 counts/g
>20-≦30 μm: 0.02-1.0 counts/g, preferably 0.02-0.7 counts/g
>30-≦40 μm: 0.02-0.6 counts/g, preferably 0.02-0.4 counts/g
>40-≦50 μm: 0.02-0.5 counts/g, preferably 0.02-0.3 counts/g
>50-≦80 μm: 0.02-0.4 counts/g, preferably 0.02-0.2 counts/g
>80-≦200 μm: 0.02-0.4 counts/g, preferably 0.02-0.2 counts/g
>200-≦400 μm: 0.02-0.2 counts/g, preferably 0.02-0.1 counts/g

In this connection a contiguous fluorescing region on the Teflon filter is automatically detected under the conditions specified above (wavelength, overall magnification, illumination time) and is counted as 1 “count” (in other words the counted particles may be one particle itself or an area of contiguous clustered particles—both will be counted as “1” count). The individual fluorescing particles present on the Teflon filter are counted. The total number of fluorescing particles is divided by the mass of the polycarbonate melt weighed out in the respective batch, and the particle count (fluorescing) referred to one gram of polycarbonate (counts/g) is thereby obtained.

The present invention furthermore provides the carrier, produced from the polycarbonate, for an optical disc (or plate), characterised in that the carrier is produced from the aforementioned polycarbonate.

On account of the rheological properties of these transparent fluorescing particles, they can be separated only with difficulty however from the substrate material. Since these particles are not hard but are viscous, then for example at high pressures or high temperatures, at which the polymer matrix exists as a melt, they are not or only insufficiently retained by conventional filters. This applies for example to conventional thin-layer metal screens. This is also the case if the pore size of the filter is significantly smaller than the mean diameter of the fluorescing particles. At higher pressures and/or higher temperatures the deformability of the particles increases, with the result that these particles can easily pass through conventional filter fabrics with small pore diameters.

In order to obtain polycarbonates with the particle size distribution according to the invention, certain filtration media can be used in order to retain particles of critical size, i.e. outside the range according to the invention. In this connection various parameters such as pressure, concentration and temperature must be adjusted so that, with the aid of the method described above, it is ensured that the particle counts lie in the range according to the invention. Furthermore, during the production of the substrate material according to the invention certain process parameters can be adjusted in order to prevent the formation of fluorescing particles of critical size. For this, melt-conducting lines of conventional steel may for example be replaced by tubes of special alloys, such as for example Hastelloy. In addition provision may be made so that the gradient between the tube temperature and reactor temperature and the temperature in the polymer melt does not become too large. This is discussed in more detail hereinbelow.

These measures or combinations of these measures serve to obtain the substrate material according to the invention.

The present invention is thus based on providing polycarbonates according to the invention having the properties according to the invention and using them for the purpose of producing therefrom the injection molded bodies according to the invention.

The production of the polycarbonates according to the invention may take place according to the melt polymerisation process as well as the interfacial polymerisation process. The interfacial polymerisation process and the melt polymerisation process are described in many places in the literature. Reference may be made for example to H. Schnell, Chemistry and Physics of Polycarbonates, Polymer Reviews, Vol. 9, Interscience Publishers, New York 1964p. 33 ff., to Polymer Reviews, Vol. 10, “Condensation Polymers by Interfacial and Solution Methods”, Paul W. Morgan, Interscience Publishers, New York 1965, Chapter VIII, p. 325, to Drs U. Grigo, K. Kircher and P. R-Müller “Polycarbonate” in Becker/Braun, Kunststoff-Handbuch, Vol. 3/1, Polycarbonate, Polyacetale, Polyester, Celluloseester, Carl Hanser Verlag Munich, Vienna 1992, p. 118-145 as well as to EP-A 0517044 regarding the interfacial polymerisation process.

According to this process the phosgenation of a disodium salt of a bisphenol (or of a mixture of different bisphenols) in aqueous-alkaline solution (or suspension) takes place in the presence of an inert organic solvent or solvent mixture, which forms a second phase. The resulting oligocarbonates, which are present mainly in the organic phase, are condensed with the aid of suitable catalysts to form high molecular weight polycarbonates dissolved in the organic phase. The organic phase is finally separated and the polycarbonate is isolated therefrom by various working-up steps.

Suitable diphenols for the production of the polycarbonates to be used according to the invention include for example hydroquinone, resorcinol, dihydroxydiphenyl, bis-(hydroxyphenyl)-alkanes, (bis-hydroxyphenyl)-cycloalkanes, bis-(hydroxyphenyl)-sulfides, bis-(hydroxyphenyl)-ethers, bis-(hydroxyphpenyl)-ketones, bis-(hydroxyphenyl) sulfones, bis-(hydroxyphenyl)-sulfoxides, α,α′-bis-(hydroxyphenyl)-diisopropylbenzenes as well as their alkylated, nuclear alkylated and nuclear halogenated compounds.

Preferred diphenols are 4,4′-dihydroxydiphenyl, 2,2-bis-(4-hydroxyphenyl)-1-phenylpropane, 1,1-Bis-(4-hydroxyphenyl)-phenylethane, 2,2-bis-(4-hydroxyphenyl)propane, 2,4-bis-(4-hydroxyphenyl)-2-methylbutane, 1,3-bis-[2-(4-hydroxyphenyl)-2-propyl]benzene (bisphenol M), 2,2-bis-(3-methyl-4-hydroxyphenyl)-propane, bis-(3,5-dimethyl-4-hydroxyphenyl)-methane, 2,2-bis-(3,5-dimethyl-4-hydroxyphenyl)-propane, Bis-(3,5-dimethyl-4-hydroxyphenyl)-sulfone, 2,4-bis-(3,5-dimethyl-4-hydroxyphpenyl)-2-methylbutane, 1,3-bis-[2-(3,5-dimethyl-4-hydroxyphenyl)-2-propyl]-benzene, 1-bis(4-hydroxyphenyl)-cyclohexane and 1,1-bis-(4-hydroxyphenyl)-3,3,5-trimethylcyclohexane (bisphenol TMC) as well as their mixtures.

Particularly preferred diphenols are 4,4′-dihydroxydiphenyl, 1,1-bis-(4-hydroxyphenyl)-phenylethane, 2,2-bis-(4-hydroxyphenyl)-propane, 2,2-Bix(3,5-dimethyl-4-hydroxyphenyl)-propane, 1,1-bis-(4-hydroxyphenyl)-cyclohexane and 1,1-bis-(4-hydroxyphenyl)-3,3,5-trimethylcyclohexane (bisphenol TMC) as well as their mixtures.

These and further suitable diphenols are described for example in U.S. Pat. Nos. 2,999,835; 3,148,172; 2,991,273; 3,271,367; 4,982,014 and 2,999,846, German laid-open specifications 1570 703, 2063050, 2036052, 2211956 and 3832396, French patent specification 1561518, in the monograph “H. Schnell, Chemistry and Physics of Polycarbonates, Interscience Publishers, New York 1964, p. 28ff; p. 102ff”, and in “D. G. Legrand, J. T. Bendler, Handbook of Polycarbonate Science and Technology, Marcel Dekker New York 2000, p. 72 ff.”.

In the case of the homopolycarbonates only one diphenol is used, while in the case of the copolycarbonates a plurality of diphenols are used, in which obviously the used bisphenols, like all other chemicals and auxiliary substances added to the synthesis, may be contaminated with impurities originating from their actual synthesis, handling and storage, although it is of course desirable to use raw materials that are as pure as possible.

The monofunctional chain terminators required to regulate the molecular weight, such as phenol or alkylphenols, in particular phenol, p-tert.butylphenol, iso-octylphenol, cumylphenol, their chlorocarbonic acid esters or acid chlorides of monocarboxylic acids or mixtures of these chain terminators, are added either together with the bisphenolate or the bisphenolates to the reaction, or at any suitable time during the synthesis, so long as phosgene or chlorocarbonic acid terminal groups are still present in the reaction mixture, or, in the case of acid chlorides and chlorocarbonic acid esters used as chain terminators, so long as sufficient phenolic terminal groups of the polymer being formed are available. Preferably the chain terminator or terminators are however added after the phosgenation at a site or at a point in time when phosgene is no longer present, but the catalyst has not yet been metered in, or they are added before the catalyst, together with the catalyst, or in parallel thereto.

In the same way branching agents or branching agent mixtures which are possibly used are added to the synthesis, though normally before the chain terminators. Normally trisphenols, quaterphenols or acid chlorides of tricarboxylic acids or tetracarboxylic acids are used, or also mixtures of the polyphenols or of the acid chlorides.

Some of the compounds containing three or more than three phenolic hydroxyl groups that may be used are for example phloroglucinol, 4,6-dimethyl-2,4,6-tri-(4-hydroxyphenyl)-heptene-2,4,6-dimethyl-2,4,6-tri-(4-hydroxyphenyl)-heptane, 1,3,5-tri-(4-hydroxyphenyl)-benzene, 1,1,1-tri-(4-hydroxyphenyl)-ethanes, tri-(4-hydroxyphenyl)-phenylmethane, 2,2-bis-(4,4-bis-(4-hydroxyphenyl)-cyclohexyl]-propane, 2,4-bis-(4-hydroxyphenylisopropyl)-phenol, or tetra-(4-hydroxyphenyl)-methane.

Some of the other trifunctional compounds are 2,4-dihydroxybenzoic acid, trimesic acid, cyanuric chloride and 3,3-bis-(3-methyl-4-hydroxyphenyl)-2-oxo-2,3-dihydroindole.

Preferred branching agents are 3,3-bis-(3-methyl-4-hydroxyphenyl)-2-oxo-2,3-dihydroindole and 1,1,1-tri-(4-hydroxyphenyl)-ethane.

The catalysts used in the interfacial polymerisation process are tertiary amines, in particular triethylamine, tributylamine, trioctylamine, N-ethylpiperidine, N-methylpiperidine, N-i/n-propylpiperidine; quaternary ammonium salts such as tetrabutyl ammonium-/tributylbenzyl ammonium-/tetraethyl ammonium-hydroxide/-chloride/-bromide/-hydrogen sulfate/-tetrafluoroborate; as well as the phosphonium compounds corresponding to the ammonium compounds. These compounds are described in the literature as typical interfacial polymerisation catalysts, are commercially available, and are well-known to the person skilled in the art. The catalysts may be added individually, as a mixture, or also one by one and in succession to the synthesis, optionally also before the phosgenation but preferably after the addition of phosgene, unless an onium compound or mixtures of onium compounds is/are used as catalysts, in which case the catalysts are preferably added before the phosgene is metered in. The addition of the catalyst or catalysts may take place in bulk, in an inert solvent, preferably the solvent of the polycarbonate synthesis, or also as aqueous solution, and in the case of tertiary amines, as their ammonium salts with acids, preferably mineral acids, in particular hydrochloric acid. If several catalysts are used or partial amounts of the total amount of catalyst are metered in, then of course different metering procedures may be adopted at different sites or at different times. The total amount of the catalysts used is between 0.001 and 10 mol % referred to moles of bisphenols employed, preferably 0.01 to 8 mol %, particularly preferably 0.05 to 5 mol %. In addition it is possible to produce polycarbonates also from diaryl carbonates and diphenols by the known polycarbonate process in the melt, the so-called melt transesterification process, which is described for example in WO-A 01/05866 and WO-A 01/05867. Apart from this, transesterification processes (acetate process and phenyl ester process) are described for example in U.S. Pat. Nos. 3,494,885; 4,386,186; 4,661,580; 4,680,371 and 4,680,372, in EP-A 26120, 26121, 26684, 28030, 39845, 91602, 97970, 79075, 146887, 156103, 234913 and 240301 as well as in DE-A 1495626 and 2232977.

For the production of the substrate material according to the invention, the continuous production process for polycarbonate by the interfacial polymerisation process is particularly suitable. Particularly preferred is a continuous reaction that employs a pumping circulation reactor as phosgenation reactor and tubular reactors connected downstream.

For the production of the substrate material according to the invention, in particular the subsequent manner and means for isolating the polycarbonate are also important.

The evaporation of the polycarbonate solution preferably takes place from a chlorobenzene/dichloromethane mixture with a chlorobenzene content of 20-70 wt. %, preferably 40-60 wt. %. It is particularly suitable to evaporate the polycarbonate solution in a thermal process, namely in the so-called flash process. In this, the concentration of the polymer solution and possibly also the isolation of the polymer is carried out by distilling off the solvent by super-heating and flashing the solvent. This process is well-known to the person skilled in the art; see also “Thermische Trennverfahren”, VCH Verlagsanstalt 1988, p. 114. In the known flash process polymer solutions are repeatedly heated under a slight excess pressure to temperatures above the boiling point under normal pressure, and these solutions, which are, super-heated with respect to normal pressure, are then flashed to a vessel at lower pressure, for example normal pressure. It may in this connection be advantageous not to allow the concentration stages, or in other words the temperature stages of the super-heating, to become too large, but instead choose a two-stage to four-stage process. A three-stage evaporation process with subsequent isolation of the polycarbonate via an evaporation extruder is particularly preferred. To produce the substrate material according to the invention it may be advantageous to operate in a multi-stage evaporation process, in which the temperature differences between the evaporation stages are not more than 90° C., particularly preferably not more than 60° C. Furthermore it is important to ensure an effective concentration in order to obtain a material of high quality in the final evaporation step, for which an evaporation extruder is preferably used. In this connection it is preferred if in the first evaporation stage the temperatures are 70° C.-80° C. at 0.35-0.45 bar excess pressure, in the second evaporation stage the temperatures are 125°-135° C. at 0.75-0.85 bar excess pressure, and in the third evaporation stage the temperatures are 175°-185° C. at 1.85-1.95 bar excess pressure.

The solvent residues can be removed from the thereby obtained highly concentrated polymer melts, either directly from the melt using evaporation extruders (BE-A 866991, EP-A 0411510, U.S. Pat. No. 4,980,105, DE-A 3332065), thin-film evaporators (EP-A 0267025), falling film evaporators, extrusion evaporators or by friction compaction (EP-A 0460450), optionally also with the addition of an entrainment agent such as nitrogen or carbon dioxide, or by applying a vacuum (EP-A 003996, EP-A 0256003, U.S. Pat. No. 4,423,207), or alternatively also by subsequent crystallisation (DE-A 3429960) and heating the solvent residues in the solid phase (U.S. Pat. No. 3,986,269, DE-A 2053876). In this connection isolation by means of evaporation extruders is preferred.

Granules are obtained, where possible, by direct spinning of the melt and subsequent granulation, or by using discharge extruders, from which material is spun in air under a liquid, generally water. If extruders are used then additives can be added to the melt, upstream of this extruder, optionally using static mixers or by side extruders in the extruder.

The polycarbonates according to the invention can also be obtained by controlling the production process as specified above and testing, with a coupled automated evaluation device, whether the polycarbonate has the particle size distribution of fluorescing particles according to the invention. Alternatively the production process can be followed by a filtration, with a coupled automated evaluation to check the quality of the polycarbonate.

A suitable method for filtering polycarbonate is characterised for example in that the polycarbonate melt is filtered through at least one metal mat consisting of more than one layer of thin metal wires. The wires are stapled together into plies and can if necessary be stabilised by thicker protective wires. The metal mat consists of wires of for example V4A steel, for example identified by the material No. 1.4571. The protective wires may consist for example of V4A 1.4571 or V2A 1.4541 or steel with the material number 1.4310. The mat is 5 mm to 0.1 mm thick, preferably 1 mm to 0.2 mm thick. The mat contains different compacted plies. The most compacted ply is preferably 0.05 to 0.2 mm thick. Furthermore the most compact ply preferably consists of thin wires with a diameter of 1-20 μm, preferably 2-10 μm, particularly preferably 2-7 μm. The pore size in the less compacted ply is preferably 20-60 mm, and in the most compacted ply is preferably 1-10 mm. These wires may be smooth or structured on the surface, which can be achieved by special treatment methods such as treatment with acid, for example nitric acid or citric acid, or by electropolishing.

The filter mat and all metal surfaces of the filter are thermally pretreated. The thermal pre-treatment may take place in a protective gas atmosphere such as nitrogen or argon, or in an oxidative atmosphere such as air, preferably in an oxidative atmosphere.

The thermal pre-treatment is generally carried out at temperatures from 300° to 1200° C., depending on the type of heat treatment and the corresponding heat treatment temperature. The duration of the thermal pre-treatment is generally 1 minute to 48 hours, preferably 2 minutes to 30 hours and especially 10 minutes to 24 hours, and depends on the type of heat treatment.

The thermal pre-treatment may in this connection be carried out by annealing the metal surface in a flame, by heat treatment in a muffle furnace or by heat treatment in a circulating air oven.

If the metal surfaces are annealed in a gas flame the temperatures are normally between 600° and 1500° C., preferably between 8000 and 1200° C., if the heat treatment is carried out in a muffle furnace the temperatures are between 300° and 1000° C., preferably between 6000 and 900° C., and if the heat treatment is carried out in a circulating air oven the temperatures are 2000 to 500° C., preferably 300° to 400° C.

The duration of the thermal pre-treatment at temperatures above 600° C. is generally 1 minute to 1 hour, in the temperature range from 300° to 700° C. is generally 30 minutes to 48 hours, preferably 30 minutes to 24 hours, and at temperatures from 300° to 500° C. is generally 1 to 48 hours, preferably 2 to 24 hours.

The flaming of the annealed metal parts is carried out in a sand bed or fluidised bed.

The invention is described in more detail by the following examples, but is however not restricted to these examples.

### EXAMPLES

### Method for Determining the Content of Fluorescing Particles

The analysis of the content of fluorescing particles is carried out by filtering the relevant polycarbonate sample (50 g), dissolved in dichloromethane (LiChrosolv; Merck: 1.06044 K33506244 430) (700 ml), through a Teflon filter membrane (Bohlender GmbH, D-97947 Grünsfeld) of 5 μm pore diameter and with a filter membrane thickness of 1 mm. The filter discs are dried in a vacuum and are protected by a cover against ambient dust. After filtration the filter surface is investigated (scanned) by means of a Zeiss AG, Germany, Axioplan 2 fluorescence microscope. The scanning is carried out with an excitation wavelength of 400-440 nm, an illumination time of 40 millisec per scan, and a 50× overall magnification. The fluorescing particles are detected and the data are evaluated via an image evaluation software (KS 300 3.0 from Zeiss AG). Only particles with a characteristic colour are counted, i.e. other particles, such as for example dust, are disregarded. The colour parameters for recognising the fluorescing particles are adjusted so that they are the same as the parameters of the particles found in flow interferences in optical discs. The scanning of the surface of the filter is carried out automatically via a computer-controlled object table (Zeiss AG).

A Netstal Discjet is used for the production of the molded parts according to the invention, in this case an optical disc for example. The following injection molding parameters and conditions are adjusted:

| | |
|---|---|
| Machine: | Netstal Discjet hybrid |
| | matrix: audio-stamper |
| Cycle time: | 3.2-3.6 sec (in the men- |
| | tioned examples: 3.4 sec) |
| Material temperature: | 330° C. |
| Substrate dimensions: | audio-CD |
| Tool temperature on matrix side: | 42° C. |
| Tool temperature on mirror side: | 43° C. |

The discs are provided with a reflecting layer (vacuum coating with aluminium) before the investigation for flow interferences. The discs are checked for flow interferences with a scanner. In this connection the scanner is adjusted so that only flow interferences are detected, i.e. defects such as spots, scratches and foreign body inclusions are not included. At the same time the recorded information is evaluated via an image processing software; discs with defects are screened out. Only radially running (i.e. running in the flow direction) line-shaped defects without foreign body inclusions are recognised as so-called flow interferences. In order to confirm this, the discs with a defect that have been screened out are checked visually once more.

Equipment from the Dr. Schenk GmbH Company, 82152 Planegg, Germany, is used as scanner and evaluation software.

The polycarbonate used in the following examples (bisphenol A as diphenol, p-tert. butylphenol as chain terminator) is produced by the conventional interfacial polymerisation process. A pumping circulation reactor and two connected residence reactors are used for this purpose. The bisphenolate solution (bisphenol A), the solvent and the phosgene are metered into the pumping circulation reactor and reacted therein, the first amount of sodium hydroxide solution likewise being metered into the pumping circulation reactor. The second amount of sodium hydroxide solution and the chain terminator solution (p.tert.-butylphenol in methylene chloride) are metered in upstream of the first residence reactor. The catalyst solution (N-ethylpiperidine as catalyst) is likewise metered in upstream of the second residence reactor.

The phases are separated after the second residence reactor, the organic phase being washed with ca. 1 wt. % hydrochloric acid and 5 times with water.

The polycarbonate thereby obtained has a mean molecular weight (weight average) of 17,000 to 18,000 g/mol (gel permeation chromatography measurement).

### Example 1

### Example According to the Invention

The polycarbonate produced as described above is discharged into an intermediate tank. The concentration of the polycarbonate dissolved in a mixture of dichloromethane and chlorobenzene (1:1 wt. %) is ca. 16.5 wt. %. This solution is concentrated to ca. 75% in two evaporation stages at a temperature gradient of 60° to 220° C., a pressure of 1.1 to 2.3 bar at a mean residence time of 30 minutes. This solution is further treated in a third evaporation stage, a flash stage with separator. The polycarbonate is conveyed via a heated discharge pump and fed to a granulation stage. The evaporation stages consist in each case of four preheaters with pressurisation valve, a coil evaporator and a separator with discharge pump. The polycarbonate solution is heated in the preheater—the pressurisation valve ensures that the solution does not boil in the preheater. The solvent is evaporated (flashed) in the coil evaporator and separator. In the first evaporation step the polycarbonate solution is concentrated from 16.5% to 30-35%. In the second evaporation stage the solution is further concentrated until a concentration of 70-75% is reached. In a third evaporation step, namely a flash stage with separator and discharge pump, the polycarbonate solution is concentrated still further at a mean temperature of 250° C. and a separator pressure of 100 mbar. The state in the separator is ˜10%—this corresponds to a residence time of ca. 0.5 minute. The discharge pump conveys the melt to a granulator. The polycarbonate has a mean molecular weight (weight average) of 17,000 to 18,000 g/mol.

The particle size distribution of the fluorescing particles is determined in the thereby obtained polycarbonate granules by the method specified above. The result of the investigation is shown in Table 1.

### Example 2

### Comparison Example

The polycarbonate with a molecular weight (weight average) of Mw=17,000-18,000 g/mol is produced as described above. The working-up and isolation of the polycarbonate takes place in principle as described in Example 1. However, the temperature in the third evaporation stage is 280° C. The state in the separator upstream of the discharge pump is >25% and corresponds to a mean residence time of 6.5 minutes.

The particle size distribution of the fluorescing particles is determined in the thereby obtained polycarbonate granules by the method given above. The result of the investigation is shown in Table 1.

Discs are Produced as Follows from the Polycarbonate of Examples 1 and 2:

30 kg of the granular material obtained according to Example 1 or 2 are dried for 6 hours and then processed into discs using a Netstal hybrid injection molding machine in a cycle time of 3.4 seconds under the parameters specified above. An audiostamper is used as matrix.

The results are summarised in Table 1.

TABLE 1

| | | | Example 2 |
|---|---|---|---|
| | | Example 1 | (comparison) |
| Size class | | (according to the | Number of |
| of fluorescing | | invention) Number of | fluorescing |
| particles | | fluorescing particles | particles |
| 8.0-10.0 | μm | 1.06 counts/g | 5.68 counts/g |
| 10.1-20.0 | μm | 1.46 counts/g | 6.94 counts/g |
| 20.1-30.0 | μm | 0.68 counts/g | 3.04 |
| 30.1-40.0 | μm | 0.34 | 1.76 |
| 40.1-50.00 | μm | 0.24 | 1.22 |
| 50.1-80.0 | μm | 0.16 | 1.74 |
| 80.1-200.0 | μm | 0.2 | 1.72 |
| 200.1-400.0 | μm | 0.06 | 0.36 |

| | | |
|---|---|---|
| Total count | 4.20 | 22.46 |
| Fluoresce. flow | 3.33% | 63.50% |
| interference in | | |
| the injection | | |
| molded body (CD) | | |
| (surface defect) | | |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A polycarbonate resin comprising fluorescing particles, wherein the size (diameter) distribution of said particles conforms to
8.0-≦10 μm: 0.02-2.4 counts/g,
>10-≦20 μm: 0.02-2.4 counts/g,
>20-≦30 μm: 0.02-1.0 counts/g,
>30-≦40 μm: 0.02-0.6 counts/g,
>40-≦50 μm: 0.02-0.5 counts/g,
>50-≦80 μm: 0.02-0.4 counts/g,
>80-≦200 μm: 0.02-0.4 counts/g, and
>200-≦400 μm: 0.02-0.2 counts/g,
as determined by dissolving 50 g of said polycarbonate in 700 ml of dichloromethane and filtering through a Teflon filter of 5 μm pore size, said fluorescing upon excitation wavelength of 400-440 nm, 50× magnification and illumination time of 40 msec per scan.

2. The polycarbonates according to claim 1 wherein the particle size distribution conforms to
8.0-≦10 μm: >0.02-1.2 counts/g
>10-≦20 μm: >0.02-1.6 counts/g
>20-≦30 μm: >0.02-0.7 counts/g
>30-≦40 μm: >0.02-0.4 counts/g
>40-≦50 μm: >0.02-0.3 counts/g
>50-≦80 μm: >0.02-0.2 counts/g
>80-≦200 μm: >0.02-0.2 counts/g
>200-≦400 μm: >0.02-0.1 counts/g

3. An article of manufacture comprising the polycarbonate of claim 1.

4. An article of manufacture comprising the polycarbonate of claim 2.

5. An optical disc comprising the polycarbonate of claim 1.

6. A light scattering disc comprising the polycarbonate of claim 1.
